(19) United States
(12) Patent Application Publication
(10) Pub. No.: US 2010/0049624 A1
(43) Pub. Date: Feb. 25, 2010

(54) COMMODITY MARKETING SYSTEM

(76) Inventor: Osamu Ito, Tokyo (JP)

Correspondence Address: FROMMER LAWRENCE & HAUG LLP, 745 FIFTH AVENUE, NEW YORK, NY, 10151, US

(21) Appl. No.: 12/542,763

(22) Filed: Aug. 18, 2009

(30) Foreign Application Priority Data
Aug. 20, 2008 (JP) P2008-212068

(51) Int. Cl. G06Q 30/00; G06F 17/00

(52) U.S. Cl. 705/26; 707/104.1

(57) ABSTRACT

A commodity marketing system includes: a mobile terminal performing communication for performing user authentication; a communication device recognizing the mobile terminal and performing communication; a customer database performing user authentication of a person who carries the mobile terminal through the communication device and managing personal information; an imaging device taking an image of the person who carries the mobile terminal; a synthesizing device synthesizing the image taken by imaging device with another image; a commodity database storing the other image to be synthesized by the synthesizing device; a display device displaying the image synthesized by the synthesizing device; an input device to which the person inputs information; a delivery system delivering a commodity based on the information that is input to the input device; and a transaction system performing a transaction from the person authenticated by the customer database.

### BACKGROUND OF THE INVENTION

1. Field of the Invention

The present invention relates to a commodity marketing system utilizing a signboard installed at a public space, a private land, or the like.

2. Description of Related Art

Commodity marketing has been carried out primarily in a physical store since long ago. One of the forms that do not require a physical store is door-to-door selling, which has been less common in recent years. In place of this, non-face-to-face commerce including new marketing forms such as television shopping and internet shopping has become commonplace.

However, in either case of physical stores or internet shopping, customers need to access there in order to select and purchase a commodity.

In contrast, among the methods of non-face-to-face commerce, there is a method that uses an advertisement such as newspaper advertisement and magazine advertisement so that it causes the customer who sees it by chance to become interested in the commodity and leads him/her to order the commodity. Thus, the advertisement itself has an advertising effect. Moreover, it is expected to find a wider range of buyers in the non-face-to-face commerce in which the user can proceed to a purchasing procedure.

Nevertheless, in the cases of the advertisements such as newspapers and magazines, the printed media need to be subscribed. Although the buyer target can be narrowed down, the advertisement needs to be placed on various many kinds of printed media in order to attract attention of a wider range of people.

In contrast, a signboard advertisement placed in town can attract a large number of people at one time, although it may depend on the place where it is installed. A new type of signboard advertisement called digital signage, which displays images and information has emerged in recent years. If such signboard advertisement can lead to purchasing immediately in addition to its advertising effect, further commodity sales can be expected.

The applicant of the present application has previously proposed an information processing system with improved robustness in which contents can be purchased using a PDA or the like and further a transaction process can be made (see, for example, JP-A-2004-171331).

### SUMMARY OF THE INVENTION

However, the commodities offered in the techniques such as mentioned above in the past are mainly electronic information called contents, such as music and moving images.

The invention addresses the foregoing circumstances. The invention provides a commodity marketing system that allows the users to try out commodities other than electronic information that a signboard advertisement advertises, establishes a marketing channel for the commodities, and enables sequential selling of the commodities.

Other features and specific advantages of the invention will become more readily apparent from the following detailed description of preferred embodiments of the invention.

According to the invention, marketing opportunities are increased by utilizing a signboard, which attracts people's attention, directly for the marketing system. The invention also prevents the marketing opportunities from getting away by allowing the user to directly proceed to the purchasing procedure.

A commodity marketing system according to one embodiment of the invention includes: a mobile terminal configured to perform communication for performing user authentication; a communication device configured to recognize the mobile terminal and perform communication; a customer database configured to perform user authentication of a person who carries the mobile terminal through the communication device and to manage personal information; an imaging device configured to take an image of the person who carries the mobile terminal; a synthesizing device configured to synthesize the image taken by the imaging device with another image; a commodity database configured to store the other image to be synthesized by the synthesizing device; a display device configured to display the image synthesized by the synthesizing device; an input device to which the person inputs information; a delivery system configured to deliver a commodity based on the information that is input to the input device; and a transaction system configured to perform a transaction from the person authenticated by the customer database.

The invention makes it possible to increases marketing opportunities by utilizing a signboard, which attracts people's attention, directly for the marketing system. The invention also makes it possible to prevent the marketing opportunities from getting away by allowing the user to directly proceed to the purchasing procedure.

### BRIEF DESCRIPTION OF THE DRAWINGS

FIG. 1 is a block diagram showing an example of the configuration of a commodity marketing system according to an embodiment of the invention.

FIG. 2 is an illustration schematically showing an example of connection of a mobile terminal and a communication device in the commodity marketing system.

FIG. 3 is an illustration schematically showing another example of connection of a mobile terminal and a communication device in the commodity marketing system.

FIG. 4 is an illustration schematically showing an example of interaction between the mobile terminal, the communication device, and a customer database in the commodity marketing system.

FIG. 5 is an illustration schematically showing an example of interaction between the mobile terminal, the communication device, an imaging device, a synthesizing device, a commodity database, and a display device in the commodity marketing system.

FIG. 6 is an illustration schematically showing an example of the functions of the synthesizing device and the display device in the commodity marketing system.

FIG. 7 is an illustration schematically showing an example of the function of the display device 7 in the commodity marketing system.

FIG. 8 is an illustration schematically showing a function example (1) of the synthesizing device and the input device in the commodity marketing system.

FIG. 9 is an illustration schematically showing a function example (2) of the synthesizing device and the input device in the commodity marketing system.

FIG. 10 is an illustration schematically showing an example of interaction between the imaging device, the synthesizing device, the display device, and an input device in the commodity marketing system.

FIG. 11 is an illustration schematically showing a function example (3) of the synthesizing device and the input device in the commodity marketing system.

FIG. 12 is an illustration schematically showing a function example (4) of the synthesizing device and the input device in the commodity marketing system.

FIG. 13 is an illustration schematically showing a function example (5) of the synthesizing device and the input device in the commodity marketing system.

FIG. 14 is an illustration schematically showing a function example (6) of the synthesizing device and the input device in the commodity marketing system.

FIG. 15 is an illustration schematically showing an example of interaction between the communication device, the customer database, the commodity database, the input device, and a delivery system 9 in the commodity marketing system.

FIG. 16 is an illustration schematically showing an example of interaction between the communication device, the customer database, the commodity database, the input device, and a transaction system in the commodity marketing system.

### DETAILED DESCRIPTION OF THE INVENTION

Hereinbelow, embodiments of the present invention will be described in detail with reference to the drawings. It should be noted that the invention is not limited to the following embodiments, but may be modified as appropriate without departing from the scope of the invention.

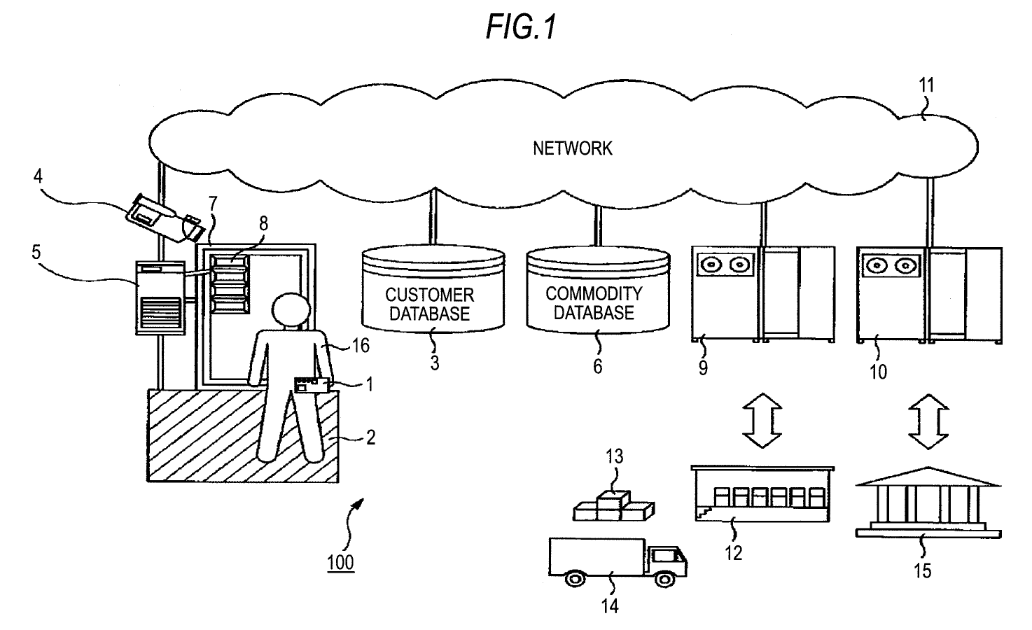

The invention is applied to, for example, a commodity marketing system 100 having a configuration as shown in FIG. 1.

By applying the invention, the commodity marketing system 100 allows the user to make trial use of commodities advertized by a signboard advertisement other than the electronic information. Moreover, it enables sequential marketing by establishing a marketing channel.

The commodity marketing system 100 includes a mobile terminal 1, a communication device 2, a customer database 3, an imaging device 4, a synthesizing device 5, a commodity database 6, a display device 7, an input device 8, a delivery system 9, and a transaction system 10.

In the commodity marketing system 100, the mobile terminal 1 is for performing communication for performing user authentication.

The communication device 2 recognizes the mobile terminal 1 and performs communication.

The customer database 3 performs user authentication of a person 16 who carries the mobile terminal 1 through the communication device 2 and manages personal information.

The imaging device 4 is for taking an image of the person 16 who carries the mobile terminal 1.

The synthesizing device 5 is for synthesizing the image taken by the imaging device 4 with another image.

The commodity database 6 is for storing other images to be synthesized by the synthesizing device 5.

The display device 7 is for displaying the image synthesized by the synthesizing device 5.

The input device 8 is for use by the person 16 to input information.

The delivery system 9 is for delivering a commodity based on the information that is input to the input device 8.

The transaction system 10 is for performing a transaction from the person authenticated by the customer database 3.

In this commodity marketing system 100, when the person 16 who carries the mobile terminal 1 enters the area of the communication device 2, a link is established between the communication device 2 and the mobile terminal 1. The communication device 2 acquires the personal information from the customer database 3 based on identification information ID held by the mobile terminal 1.

The communication device 2 issues a notification signal to the mobile terminal 1 when the information of the signboard advertisement handled by the display device 7 matches the preference information of the person 16 based on the acquired customer data.

The mobile terminal 1 that has received the notification signal lets the person 16 know the presence of the display device 7 by, for example, vibration of the mobile terminal 1 itself. In addition, notification sound may be issued from the mobile terminal 1 itself. In addition, the mobile terminal 1 itself may emit light to let the person to know the presence of the display device 7. If the mobile terminal 1 has a music reproducing function, notification sound may be added to the music that has been playing. If the mobile terminal 1 has an image reproducing function, a notification symbol may be displayed on the monitor.

After confirming the presence of the display device 7, the person 16 who carries the mobile terminal 1 performs a connection process through the mobile terminal 1 if he/she has an interest in the information (commodity). The connection process may be carried out, not only through the mobile terminal 1, but through the input device 8 that is integrated with the display device 7.

After the connection process has been performed from the person 16 who carries the mobile terminal 1, the communication device 2 acquires further information of the person 16 related to the signboard advertisement from the customer database 3, and it also acquires the commodity data for the person 16 thereto from the commodity database 6. At this time, necessary image information is sent to the synthesizing device 5. It should be noted that the customer database 3 may be managed separately for the data related to the mobile terminal 1 and the data processed by the sponsor of the signboard advertisement.

According to the connection process to the communication device 2, the imaging device 4 takes an image of the person 16 and sends the image to the synthesizing device 5.

The synthesizing device 5 generates a synthesized image from the taken image and the image information of the commodity and sends the generated image to the display device 7.

The display device 7 displays the sent image.

The person 16 sees the image displayed on the display device 7 and checks whether or not it matches his/her preference to determine whether he/she purchases it.

The person 16 who decides to purchase it performs a purchase process through the input device 8.

By the completion of the purchasing procedure, the communication device 2 gives a delivery instruction to the delivery system 9 based on the customer data and commodity data for the person 16.

In addition, the communication device 2 gives a transaction instruction to the transaction system 10 based on the customer data and commodity data for the person 16.

The delivery system 9 dispatches a stock 13 of the commodity from a warehouse 12 using a truck 14, based on the instructed delivery data. Based on the instructed delivery data, the delivery system 9 delivers the commodity with the model number that fits the person 16 who carries the mobile terminal 1 among the commodities purchased by the customers who have been authenticated by the identification information ID of the mobile terminal 1 based on the information registered in the customer database 3.

The transaction system 10 performs a transaction process with a bank 15 based on the instructed transaction data.

It should be noted that the communication device 2 through the transaction system 10 are connected via a network 11.

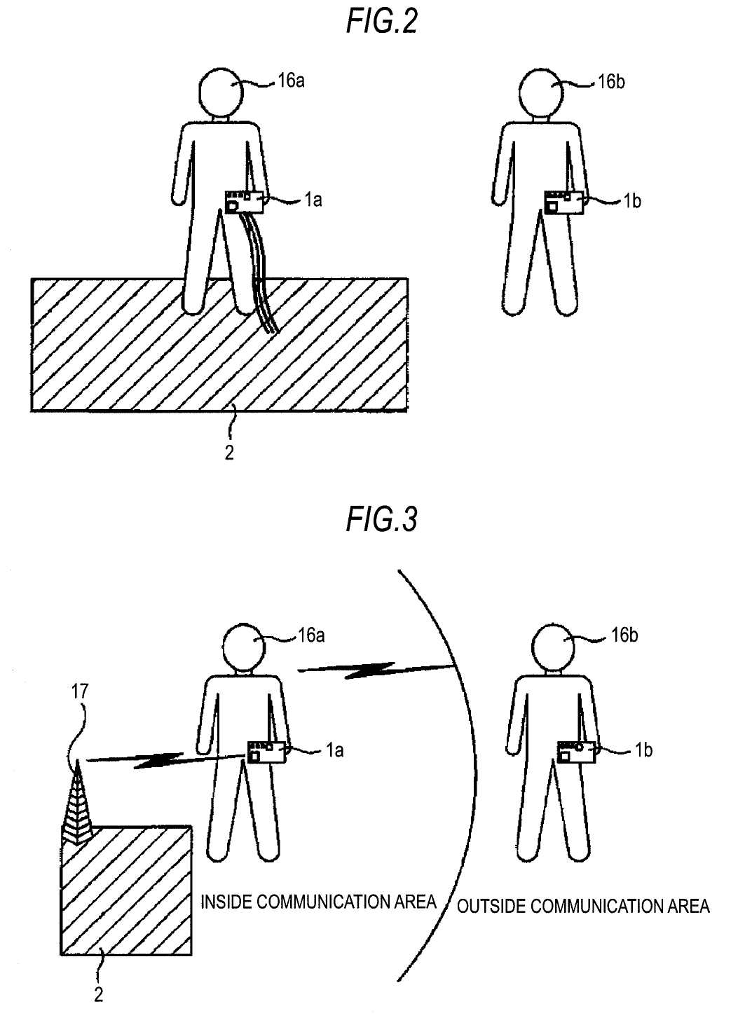

Here, an example of connection between the mobile terminal 1 and the communication device 2 in the commodity marketing system 100 is shown in FIG. 2.

The connection example shown in FIG. 2 is a connection example in which communication is performed via a human body.

In this connection example, when the person 16a who carries the mobile terminal 1a walks on the communication device 2, the mobile terminal 1a and the communication device 2 perform human body communication via a human body, so a link is established.

The mobile terminal 1b and the communication device 2 cannot perform human body communication via a human body because the person 16b who carries the mobile terminal 1b is not on the communication device 2, so a link cannot be established.

The use of the human body communication makes it possible to establish a link by limiting the area in which the information of the signboard advertisement handled by the display device 7 is to be provided. In other words, if signboard advertisements are adjacent to each other, links can be formed independently of each other.

It should be noted that the technique of a human body communication system as disclosed in JP-A-2006-303736 proposed by the applicant of the present application, for example, in which data communication is performed by an electric field formed by the presence of a human body, may be employed for the human body communication.

Another example of connection between the mobile terminal 1 and the communication device 2 in the commodity marketing system 100 is shown in FIG. 3.

FIG. 3 is another illustration showing a connection example of the mobile terminal 1 and the communication device 2 employed for this embodiment.

The connection example shown in FIG. 3 is a connection example in which communication is performed via a wireless channel.

In this connection example, when the person 16a who carries the mobile terminal 1a enters the communication area of the communication device 2, the mobile terminal 1a and the communication device 2 perform wireless communication via a wireless channel and an antenna 17, so a link is established.

The mobile terminal 1b and the communication device 2 cannot perform wireless communication via a wireless channel because the person 16b who carries the mobile terminal 1b is outside the communication area of the communication device 2, so a link cannot be established.

The use of the wireless communication with a narrow communication area makes it possible to establish a link by limiting the area in which the information of the signboard advertisement handled by the display device 7 is to be provided. In other words, if signboard advertisements are adjacent to each other, links can be formed independently of each other.

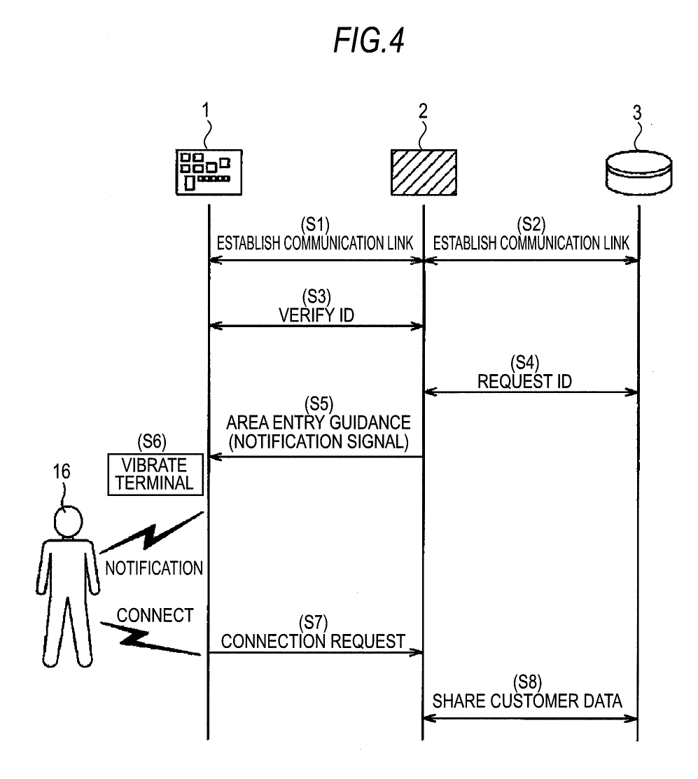

FIG. 4 is a sequence diagram showing an example of interaction between the mobile terminal 1, the communication device 2, and the customer database 3 in the commodity marketing system 100.

Here, the initial time sequence at which the marketing system starts to function will be described. It should be noted, however, that the description of such processes as the initial setting of the system are omitted.

First, by the entry of the mobile terminal 1 into the communication area the communication device 2, a series of operations of the system starts, and communication link establishment between the mobile terminal 1 and the communication device 2 (S1) and communication link establishment between the communication device 2 and the customer database 3 (S2) take place. Next, the identification information ID held by the mobile terminal 1 is confirmed between the mobile terminal 1 and the communication device 2 (S3), and customer data are confirmed between the communication device 2 and the customer database 3 based on the identification information ID (S4). The customer database 3 stores and manages various data that have been registered from the person 16 in advance, and it makes permission and provides data for the user authentication from the communication device 2. If the information of the signboard advertisement handled by the display device 7 that is paired with the communication device 2 is determined to be the one that provides information to the identification information ID held by the mobile terminal 1, based on the customer data of the customer database 3, the communication device 2 issues a notification signal to the mobile terminal 1 (S5). The mobile terminal 1 that has received the notification signal informs the person 16 that it has received the notification signal, for example, by vibrating the mobile terminal 1 itself (S6). In addition, notification sound may be issued from the mobile terminal 1 itself. Moreover, the mobile terminal 1 itself may emit light. If the mobile terminal 1 has a music reproducing function, notification sound may be added to the music that has been playing. If the mobile terminal 1 has an image reproducing function, a notification symbol may be displayed on the monitor. The person 16 who has confirmed the notification signal performs a connection process through the mobile terminal 1 if he/she has an interest in the notified signboard advertisement information. The communication device 2 that has received the connection request from the mobile terminal 1 requests the customer database 3 to provide further detailed customer data based on the identification information ID held by the mobile terminal 1 (S7). Then, the customer data is shared between the communication device 2 and the customer database 3 (S8). The customer database 3 accumulates, as a history, the information indicating, for example, that the information of the signboard advertisement handled by the display device 7 that is paired with the communication device 2 is accessed by the identification information ID held by the mobile terminal 1.

It should be noted that the connection process may be performed not just by the mobile terminal 1 but by the input device 8 provided separately, but in that case, an identification information ID authentication unit is required separately.

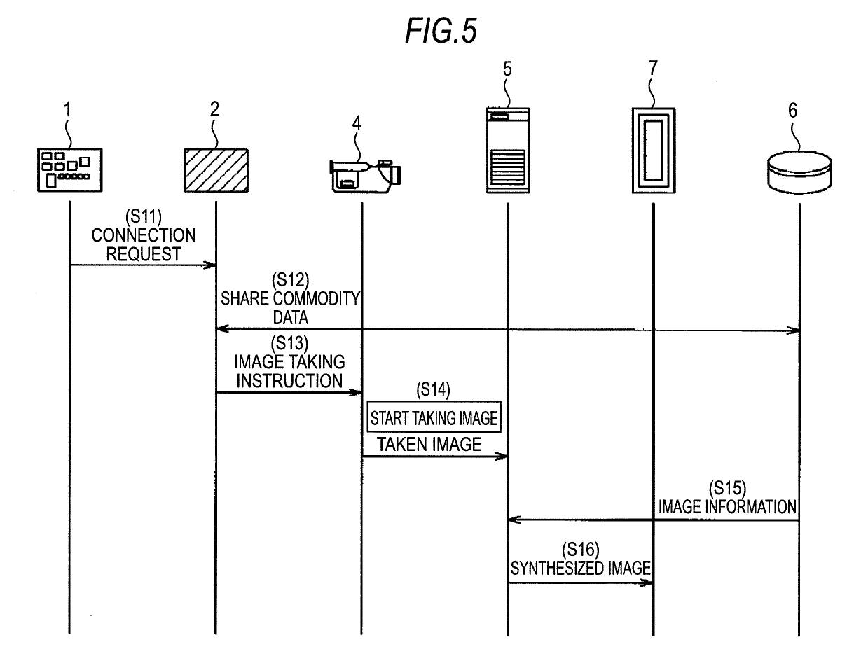

FIG. 5 is a sequence diagram showing an example of interaction between the mobile terminal 1, the communication device 2, the imaging device 4, the synthesizing device 5, the commodity database 6, and the display device 7 in the commodity marketing system 100.

Here, the time sequence from the connection request to the image displaying shown in FIG. 4 will be described.

First, the communication device 2 receives a connection request from the mobile terminal 1 (S11). Upon this request, the communication device 2 acquires the commodity data of the signboard advertisement handled by the display device 7 that is paired with the communication device 2 from the commodity database 6 (S12). At that time, it collects the commodity data based on the customer data that has already been acquired. In addition, the communication device 2 instructs the imaging device 4 that is paired with the communication device 2 to start shooting (S13). The imaging device 4 that has been instructed to start shooting takes an image of the object, and sends the taken image to the synthesizing device 5 (S14). At this time, the object is the person 16 who possesses the mobile terminal 1. The imaging device 4 may have a function to track the object according to the movement of the person 16. In addition, the shooting position of the imaging device 4 itself may shift in response to the movement of the person 16. For example, the shooting position and direction may be shifted to a position facing the person 16 according to the line of sight of the person 16. The commodity database 6 sends image information of an available commodity data that matches the person 16 to the synthesizing device 5, based on the customer data from the communication device 2 (S15). It should be noted that the exchange of data between the synthesizing device 5 and the commodity database 6 may be carried out, not directly, but through the communication device 2 or the like. The synthesizing device 5 generates a synthesized image of the person 16 and a commodity based on the taken image from the imaging device 4 and the image information from the commodity database 6, and sends the synthesizing image to the display device 7 (S16). At this time, the synthesizing device 5 synthesizes the image of the person 16 taken by the imaging device 4 and the image information from the commodity database 6 according to the movement of the person 16. This synthesized image is synthesized as follows. For example, if the commodity is a piece of clothes, the image should appear as if the person 16 is trying it on. If the commodity is a fashion accessory such as a bag, the image should appear as if the person 16 is holding it. If the commodity is an accessory such as a necklace, the image should appear as if the person 16 is putting it on. The display device 7 displays the synthesized image from the synthesizing device 5 onto the screen on which the signboard advertisement is displayed.

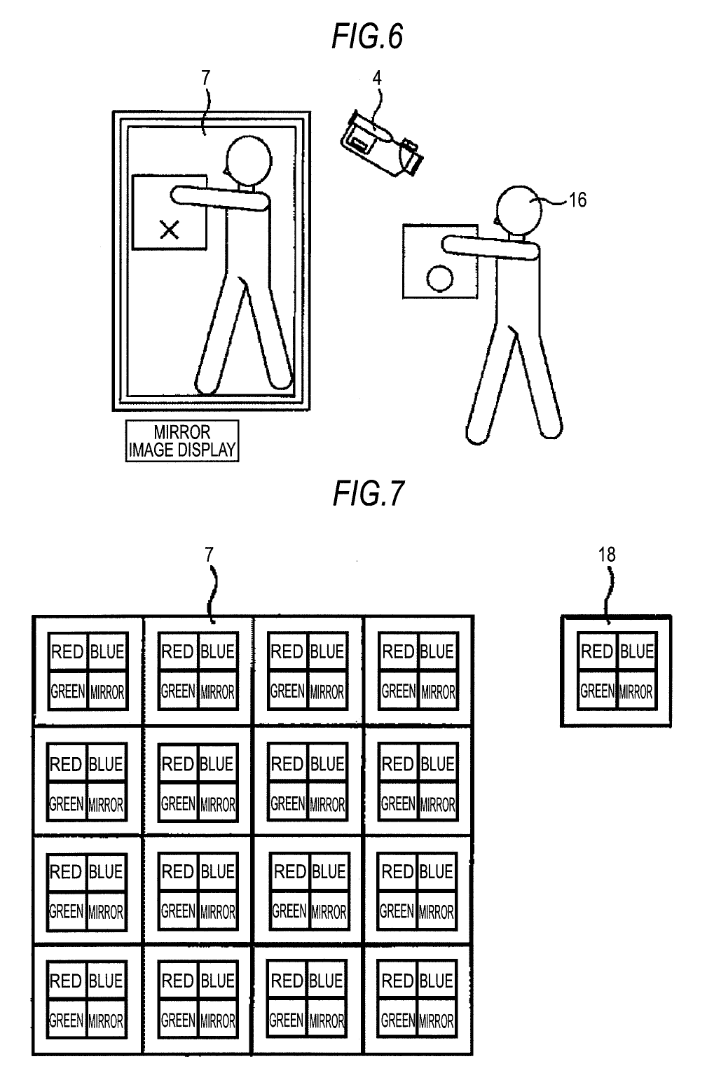

An example of the functions of the synthesizing device 5 and the display device 7 in the commodity marketing system 100 is shown in FIG. 6.

Usually, when looking at an image taken on a display screen, an image seen in a shooting direction is displayed. That is, when an image of the person 16 is taken by the imaging device 4 and the image that has undergone a synthesizing process by the synthesizing device 5 is viewed by the person 16 on the display device 7, the appearance of the person himself/herself is displayed as it is. Specifically, the right hand of the person 16 is positioned on the left hand side of the screen of the display device 7.

Apart from taking images, a mirror is another way to see the appearance of the person himself/herself. In the mirror, the right hand of the person himself/herself is shown on the right side facing the mirror surface, which is opposite to the normal display direction of the display device 7.

In this embodiment, an image is displayed in the image processing of the synthesizing device 5 and the image displaying of the display device 7 so that the image is flipped horizontally, i.e., in an opposite direction to the normal display direction. Thereby, the person 16 can recognize the display device 7 as if it is a mirror. As a result, it is possible to obtain the effect that he/she perceives the person's image synthesized with the commodity as if, for example, he/she is trying it on in front of a mirror.

In the real mirror, the appearance and background are different depending on the line of sight of the person who sees the mirror. If the imaging device 4 is fixed, the position of the line of sight is limited, so the synthesizing device 5 becomes unable to generate mirror images because of the movement of the person 16. In view of this problem, the imaging device 4 shifts the shooting position sequentially according to the movement and the line of sight of the person 16. Alternatively, a plurality of imaging devices 4 are installed at different positions, and the synthesizing device 5 uses the images taken by the imaging devices 4 by switching the images one after another according to the movement and the line of sight of the person 16.

In addition, the display device 7 may have a three-dimensional display function in order to enhance the mirror effect, and the synthesizing device 5 may generate a synthesized image for the three-dimensional display.

Another example of the functions of the synthesizing device 5 and the display device 7 in the commodity marketing system 100 is shown in FIG. 7.

In the function example shown in FIG. 6, the mirror image is generated by the synthesizing device 5. In contrast, in the function example shown in FIG. 7, the display device 7 is allowed to have a usual mirror function, and it is configured to operate the function to emit what is called screen light at only the location at which a synthesized image is to be displayed. The display device 7 has a multiplicity of mirror surface pixels 18 arranged in an array. Each of the mirror surface pixels 18 emits “red”, “blue”, or “green” light, for example, in response to a signal from the synthesizing device 5. Moreover, it causes “mirror” elements to function according to a signal from the synthesizing device 5. These “mirror” elements have what is called the original mirror function, by which it reflects the light projected onto the display device 7.

For example, if there is no image information that the synthesizing device 5 needs to synthesize, all the mirror surface pixels 18 are turned to “mirror”, so that the display device can function as a simple mirror. On the other hand, in the case where the image taken by the synthesizing device 5 does not need to be displayed on the display device 7, all the mirror surface pixel 18 are caused to emit “red”, “blue”, or “green” light, so that it can function as a simple screen. The light source used in this case is not limited to the one that emits each single color of light, but it may the one that emits a plurality of colors of lights at the same time.

In the synthesizing device 5 shown in the function example of FIG. 6, a taken image and image information are synthesized inside the synthesizing device 5, so the synthesizing process for the movement of the person 16 is a closed process. This means that, when the synthesizing process takes a long time, the image displayed on the display device 7 starts to move later than the actual movement.

On the other hand, in the synthesizing device 5 in the function example shown in FIG. 7, the image information to be synthesized is shifted according to the movement of the person 16. Therefore, switching of the mirror surface pixels 18 (light emission and reflection) needs to track the actual movement at high speed. For example, in the case where an arm of the person 16 comes over a plurality of blocks of the mirror surface pixels 18 that are emitting light for displaying the synthesized information, the person 16 cannot see the arm reflected on the mirror and the arm disappears for a moment if the tracking is slow.

However, considering human behavior patterns, it is believed that, in general, the person 16 does not continue to move quickly in front of the display device 7 but he/she tends to stop his/her movement in order to confirm the screen in the embodiment of the invention. For this reason, the function of the embodiment is believed to be exhibited even if a display failure occurs on the display device 7 for a moment.

In addition, the image from the imaging device 4 is required by the synthesizing device 5 in order to identify where the person 16 is in front of the display device 7. However, the complicated processes that are necessary in the function example shown in FIG. 6, such as identifying the shooting position of the imaging device 4 considering the line of sight of the person 16, are no longer necessary.

It should be noted that the arrangement of the elements of the mirror surface pixels 18 are not limited to the arrangement shown in FIG. 7, and the size of each of the elements does not need to be uniform. Furthermore, the light emitting element and the light reflecting element may be configured to have a dual structure such that the reflecting element having the “mirror” function can switch over the functions of reflection and transmission (i.e., passing through the light emitted from the light emitting element). In other words, it is desirable that they are configured so that the synthesized image can be viewed from the person 16 appropriately.

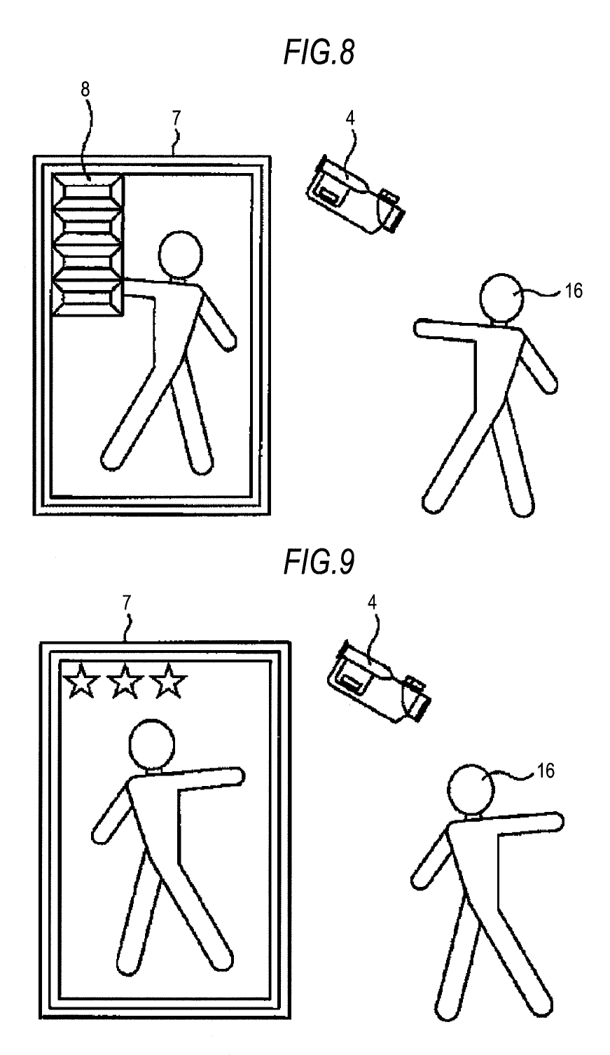

An example of the functions of the synthesizing device 5 and the input device 8 in the commodity marketing system 100 is shown in FIG. 8.

The input device 8 is for performing switching of commodities to be synthesized (commodities themselves, sizes thereof, colors thereof, shapes thereof, and the like), the procedures at the time of purchasing, and the like. The synthesizing device 5 adds a symbol of the input device 8 to the synthesized image of the person 16 and the commodity according to a purchasing sequence, and it displays the image on the display device 7.

The person 16 makes a movement as if he/she touches the symbol of the item on the synthesized image that he/she desires to input without directly touching the display device 7 by moving his/her hand or the like displayed on the display device 7. When the hand of the person 16 touches onto the position at which the symbol for the input device 8 is synthesized, the input device 8 determines that an input has been made, and it carries out the procedure of the input process in the purchasing sequence. In addition, the result of the determination is displayed on the display device 7 as a synthesized image through the synthesizing device 5.

Another example of the functions of the synthesizing device 5 and the input device 8 in the commodity marketing system 100 is shown in FIG. 9.

In the function example shown in FIG. 9, the input means to the input device 8 is a predetermined movement. In the case where it is determined that the person 16 has performed a predetermined movement while the input device 8 is waiting for an input process in the purchasing sequence, the input device 8 carries out the procedure of the input process performed in the purchasing sequence.

At that time, the synthesizing device 5 adds a message or the like to the synthesized image such that the person 16 can recognize the input device 8 is waiting for an input process or that the input process has completed, and it displays the image on the display device 7.

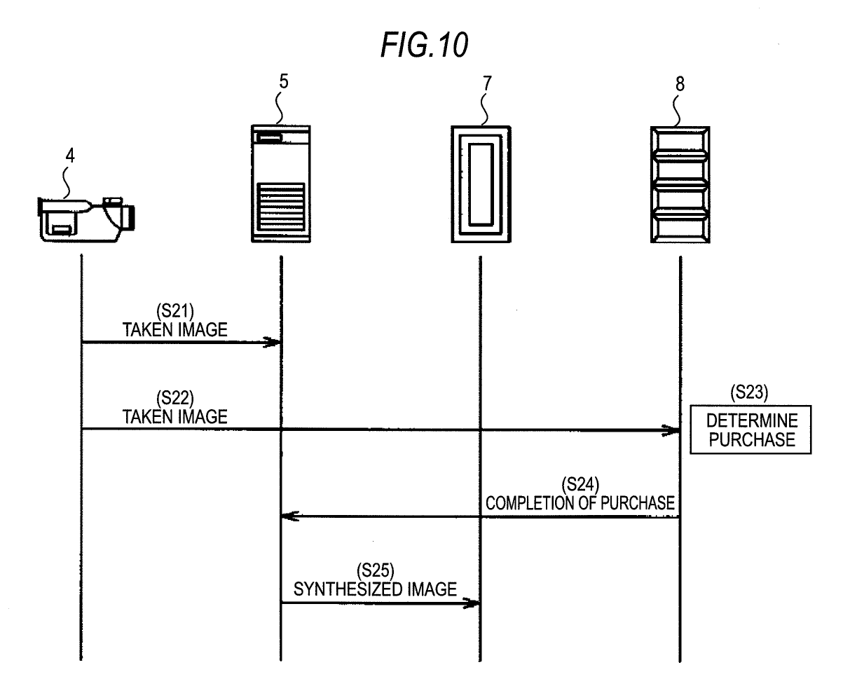

FIG. 10 is a sequence diagram showing an example of interaction between the imaging device 4, the synthesizing device 5, the display device 7, and the input device 8 in the commodity marketing system 100.

Here, the time sequence from the movement image taking at the time of purchase decision to the synthesized image display at the completion of purchase in the purchasing sequences of FIGS. 8 and 9 will be described.

First, the imaging device 4 takes an image of the person 16 and sends the taken image to the synthesizing device 5 and the input device 8 (S21, S22) The synthesizing device 5 keeps sending the synthesized image to the display device 7, as in the previous cases.

In the input device 8, the movement of the person 16 is analyzed from the image taken by the imaging device 4, and it is determined whether or not the movement indicates that he/she has a purchase intention (S23). If it is determined that the movement indicates that he/she has a purchase intention, the purchase is completed, and an instruction is given to the synthesizing device 5 so that the synthesizing device 5 synthesizes a display for purchase completion (S24) in order to inform the person 16 of the result of the determination. The synthesizing device 5 that has received the instruction adds a message or the like to the synthesized image, and displays the image on the display device 7 (S25).

It should be noted that the report of various results to the person 16 is not limited to the communication via the display device 7.

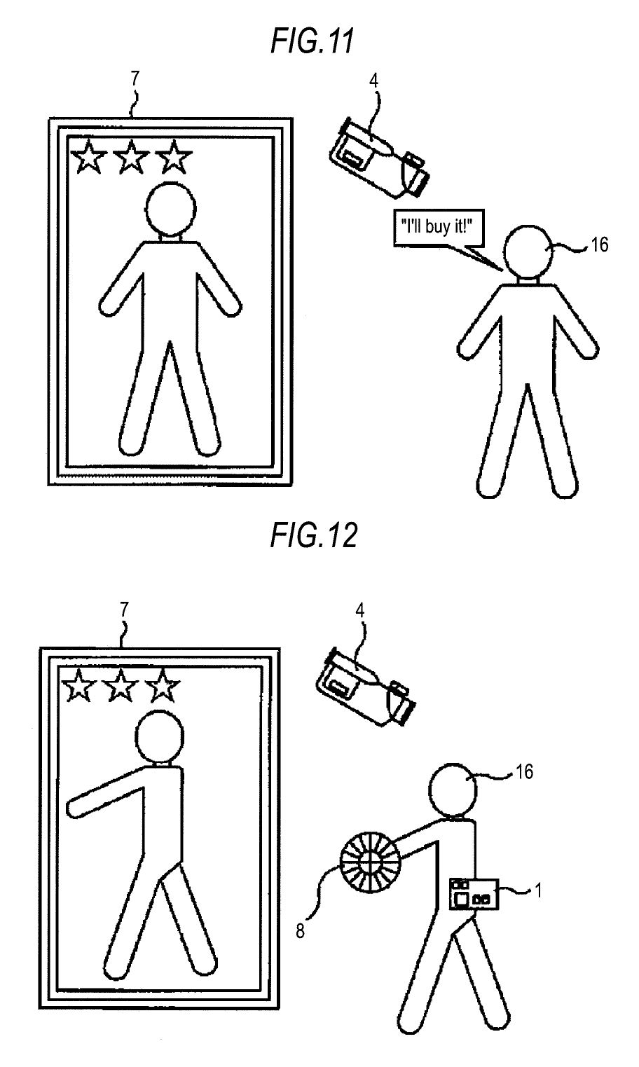

Another example of the functions of the synthesizing device 5 and the input device 8 in the commodity marketing system 100 is shown in FIG. 11.

In the function example shown in FIG. 11, the input means to the input device 8 is a predetermined word.

In the case where it is determined that the person 16 has spoken a predetermined word while the input device 8 is waiting for an input process in the purchasing sequence, the input device 8 carries out the procedure of the input process in the purchasing sequence.

At that time, the synthesizing device 5 adds a message or the like to the synthesized image such that the person 16 can recognize the input device 8 is waiting for an input process or that the input process has completed, and it displays the image on the display device 7.

Yet another example of the functions of the synthesizing device 5 and the input device 8 in the commodity marketing system 100 is shown in FIG. 12.

In the function example shown in FIG. 12, the input means to the input device 8 is a human body communication between the mobile terminal 1 and the input device 8 via the person 16.

In the case where the person 16 who has the mobile terminal 1 that has the identification information ID acquired at the time of establishment of a communication link has touched the input device 8 while the input device 8 is waiting for an input process in the purchasing sequence, the input device 8 carries out the procedure of the input process in the purchasing sequence.

At that time, the synthesizing device 5 adds a message or the like to the synthesized image such that the person 16 can recognize the input device 8 is waiting for an input process or that the input process has completed, and it displays the image on the display device 7.

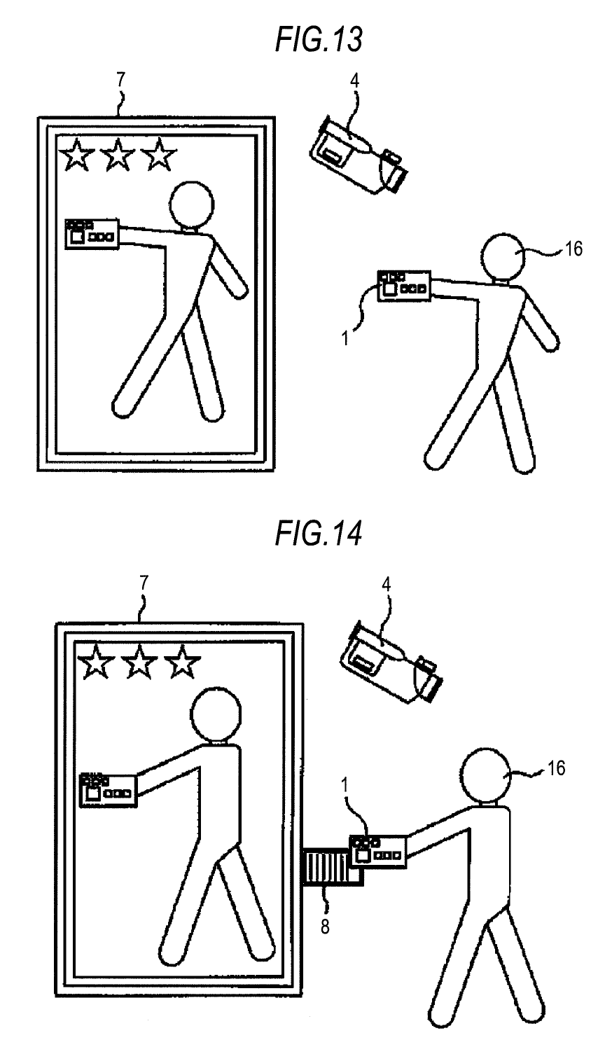

Still another example of the functions of the synthesizing device 5 and the input device 8 in the commodity marketing system 100 is shown in FIG. 13.

In the function example shown in FIG. 13, the input means to the input device 8 is an input process from the mobile terminal 1 to the communication device 2.

In the case where an input process is performed through the communication device 2 from the mobile terminal 1 that has the identification information ID acquired at the time of establishment of a communication link while the input device 8 is waiting for an input process in the purchasing sequence, the input device 8 carries out the procedure of the input process in the purchasing sequence.

At that time, the synthesizing device 5 adds a message or the like to the synthesized image such that the person 16 can recognize the input device 8 is waiting for an input process or that the input process has completed, and it displays the image on the display device 7.

Further another example of the functions of the synthesizing device 5 and the input device 8 in the commodity marketing system 100 is shown in FIG. 14.

In the function example shown in FIG. 14, the input means to the input device 8 is non-contact communication using the mobile terminal 1.

The input device 8 has the function to input information by placing the mobile terminal 1 over a main unit. In the case where the mobile terminal 1 that has the identification information ID acquired at the time of establishment of a communication link is placed over the input device 8 while the input device 8 is waiting for an input process in the purchasing sequence, the input device 8 carries out the procedure of the input process in the purchasing sequence.

At that time, the synthesizing device 5 adds a message or the like to the synthesized image such that the person 16 can recognize the input device 8 is waiting for an input process or that the input process has completed, and it displays the image on the display device 7.

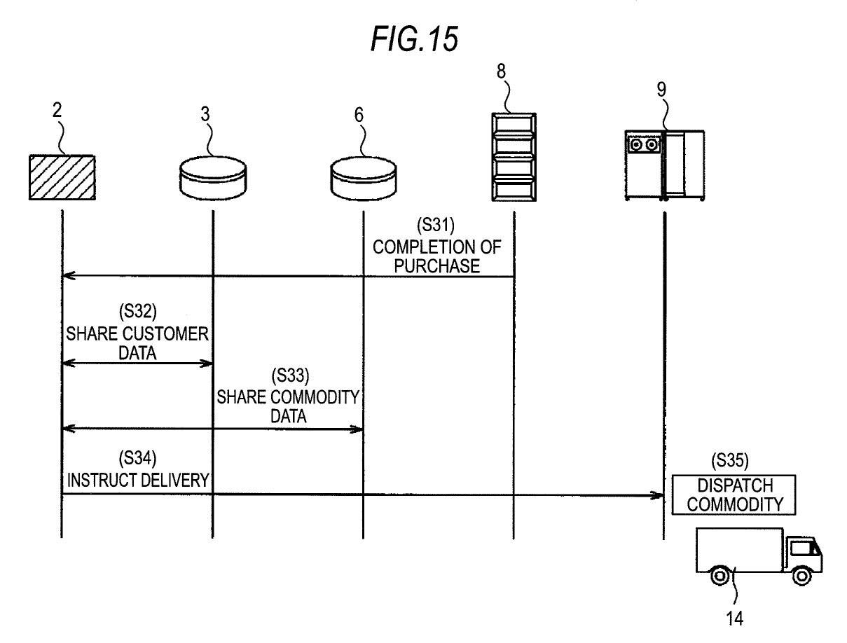

FIG. 15 is a sequence diagram showing an example of interaction between the communication device 2, the customer database 3, the commodity database 6, the input device 8, and the delivery system 9 in the commodity marketing system 100.

Here, the time sequence from the completion of the purchase to the delivery of the commodity will be described.

First, the input device 8 issues the completion of the purchase to the communication device 2 (S31). At that time, the input device 8 tells the communication device 2 which of the commodities the person 16 who possesses the mobile terminal 1 that has the identification information ID acquired at the time of establishment of the communication link has purchased.

Based on the customer database 3 and the customer data, the communication device 2 confirms with the person 16 that the commodity that is sold is correct, and the customer database 3 stores the history indicating that the person 16 has purchased the specific commodity (S32).

In addition, the communication device 2 confirms the stock of the commodity based on the commodity database 6 and commodity data, and the commodity database 6 updates the sales history of the specific commodity (S33). It is also possible that a notification of the commodity delivery date, including the case where there is no commodity stock, may be made to the person 16 through the display device 7.

Then, the communication device 2 issues a delivery instruction for the specific commodity (item number) to the delivery system 9 (S34). At this time, the information such as the delivery destination is provided from the customer data of the identification information ID acquired at the time of establishment of the communication link. It should be noted that the delivery destination is not limited to the customer data that has been registered in advance, but it may be set according to the instruction made by the person 16 via the input device 8 at the time of the purchasing.

Based on the instructed delivery data, the delivery system 9 delivers the commodity with the model number that fits the person 16 who carries the mobile terminal 1 among the commodities purchased by the customers who have been authenticated by the identification information ID of the mobile terminal 1 based on the information registered in the customer database 3 (S35).

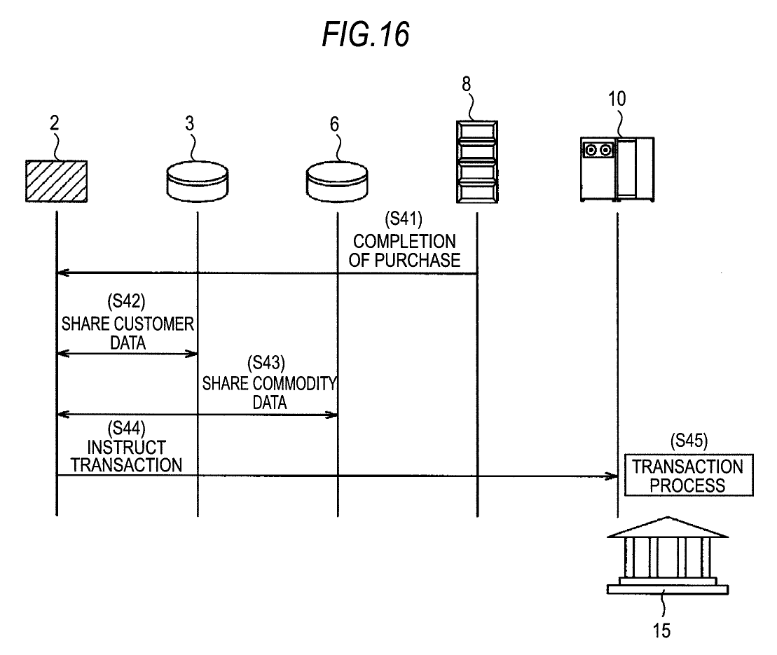

FIG. 16 is a sequence diagram showing an example of interaction between the communication device 2, the customer database 3, the commodity database 6, the input device 8, and the transaction system 10 in the commodity marketing system 100.

Here, the time sequence from the completion of the purchase to the transaction process will be described.

First, the input device 8 issues the completion of the purchase to the communication device 2 (S41). At that time, the input device 8 tells the communication device 2 which of the commodities the person 16 who possesses the mobile terminal 1 that has the identification information ID acquired at the time of establishment of the communication link has purchased.

Based on the customer database 3 and the customer data, the communication device 2 confirms with the person 16 that the commodity that is sold is correct, and the customer database 3 stores the history indicating that the person 16 has purchased the specific commodity (S42).

In addition, the communication device 2 confirms the stock of the commodity based on the commodity database 6 and commodity data, and the commodity database 6 updates the sales history of the specific commodity (S43). It is also possible that a notification of the commodity delivery date, including the case where there is no commodity stock, may be made to the person 16 through the display device 7.

Then, the communication device 2 issues a transaction instruction for the specific commodity (price) to the transaction system 10 (S44). At this time, the information such as the account to be deducted is provided from the customer data of the identification information ID acquired at the time of establishment of the communication link. It should be noted that the account to be detected is not limited to the customer data that has been registered in advance, but it may be set according to the instruction made by the person 16 via the input device 8 at the time of the purchase.

According to the transaction instruction, the transaction system 10 carries out a transaction process for the customer authenticated by the identification information ID of the mobile terminal 1 based on the information registered in the customer database 3.

Next, using such a commodity marketing system 100 makes it possible to obtain the following advantageous effects that were not obtained in the past.

First, the customer can purchase the commodity without going to the store. Moreover, there is no case that the commodity is out of stock just when the customer visits the store. Furthermore, even in such cases that the commodity cannot be stocked in the physical store for space limitations, the customer can select a favorite commodity among many groups of commodities.

From the viewpoint of the store side, the necessity of the signboard advertisement has been recognized, and advertising itself has been considered as important, other than the marketing by means of stores, internet shopping, and the like. However, it has been necessary to get the customer to come to the store in order to obtain the effect resulting from the advertising. Due to this marketing system, the signboard advertisement that has been used for advertising to date is used directly for commodity marketing. Thus, it becomes possible to obtain more sales opportunities.

Furthermore, without running a physical store, commodity marketing can be conducted at a place such that a signboard advertisement can be installed like a vending machine, so marketing opportunities can be increased. In addition, it is possible with the signboard advertisement to operate 24 hours a day even if it is impossible with the physical store. This makes possible to widen the marketing opportunity to the kind of customers for whom the commodity has not been able to sell because of the restriction in terms of opening hours. It should be noted that, although these problems have been solved by internet shopping in the past, it becomes possible to attract a greater number of kinds of customers by utilizing a signboard advertisement as a medium, even without guiding them to access to a webpage. Moreover, it is also possible to make customers have a buying motive through more realistic experience obtained by the display device 7. It is believed that customers tend to have more inspiration and it is more likely to lead the customers to purchase when looking at the commodity with his/her appearance on the display device 7 like a mirror, rather than pasting an image of his/her face on a dummy in an internet shopping site and seeing it on a screen of a personal computer.

In addition, the signboard advertisement maybe installed in an area restricted to a certain degree, not in a public area, so it becomes possible even for the kind of customers who have felt the service by sales clerks unpleasant in the past to examine the commodity without the sales clerks. Rather, it becomes possible to eliminate the loss caused by shoplifting because customers do not take the commodity directly in their hands.

It should be noted that there are matters that customers are unable to know, such as the texture of the commodity. However, sales through internet shopping has also been increasing currently, and it is believed that sufficient research and study can be made about the commodities that can be handled by the signboard advertisement.

In addition, for the sponsor of the advertisement who introduces this commodity marketing system 100, it is possible to prevent loss of commodity marketing opportunity because of lack of stock, and to reduce the cost for delivering a large number of commodities to the store. What is more, potential needs to the business hours demanded by customers may be obtained as one indicator from the statistics data such as sales time periods, which can lead to further business development.

It should be noted that the invention is not limited to the foregoing embodiments. For example, the commodity database 6 is provided via the network 11, but it may be combined with the display device 7 or the like on the signboard advertisement side. It is possible to employ a configuration in which a master commodity database 6 is provided and each of commodity databases 6 is updated together with the information updating of the master commodity database 6.

Moreover, although the communication device 2 and the synthesizing device 5 are described to have central roles in various sequences, it is also possible to separately provide a device for controlling the sequences integrally.

The display device 7 has the function to display the person 16. However, taking into consideration that it is installed in a public area, the viewing angle may be deliberately narrowed so that the synthesized image of the person 16 cannot be seen by a third person. In that case, it is possible to configure the system so that an original advertising image of the signboard advertisement can be viewed by the third person, or that a synthesized image of a model who is not the person 16 can perform the same movement as the person 16 does.

In addition, this commodity marketing system 100 is also applicable to an application in which a signboard advertisement and a vending machine front face are integrated. For example, the display device 7 may have the role of a vending machine front face in the past so that a commodity is offered one after another and a billing process or a transaction via a network is performed at the site.

The present application contains subject matter related to that disclosed in Japanese Priority Patent Application JP 2008-212068 filed in the Japan Patent Office on Aug. 20, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A commodity marketing system comprising:
a mobile terminal configured to perform communication for performing user authentication;
a communication device configured to recognize the mobile terminal and perform communication;
a customer database configured to perform user authentication of a person who carries the mobile terminal through the communication device and to manage personal information;
an imaging device configured to take an image of the person who carries the mobile terminal;
a synthesizing device configured to synthesize the image taken by imaging device with another image;
a commodity database configured to store the other image to be synthesized by the synthesizing device;
a display device configured to display the image synthesized by the synthesizing device;
an input device to which the person inputs information;
a delivery system configured to deliver a commodity based on the information that is input to the input device; and
a transaction system configured to perform a transaction from the person authenticated by the customer database.

2. The commodity marketing system as set forth in claim 1, wherein the mobile terminal has a function of performing communication with the communication device via a human body.

3. The commodity marketing system as set forth in claim 1, wherein the mobile terminal has a function of performing communication with the communication device via a wireless channel.

4. The commodity marketing system as set forth in claim 1, wherein the communication device has a function of detecting approach of the mobile terminal, and a function of making an enquiry to the customer database based on identification information of the mobile terminal, and transmitting a notification signal to the mobile terminal if it is determined that the mobile terminal is a communication subject.

5. The commodity marketing system as set forth in claim 4, wherein the mobile terminal has a function of informing the person of receipt of the notification signal when receiving the notification signal from the communication device.

6. The commodity marketing system as set forth in claim 1, wherein the customer database has a function of storing and managing various data that have been registered from the person in advance, and making permission and providing data for the user authentication from the communication device.

7. The commodity marketing system as set forth in claim 4, wherein the imaging device has a function of taking an image of the person when receiving a notification indicating approach of an image taking subject from the communication device.

8. The commodity marketing system as set forth in claim 1, wherein the imaging device has a function of tracking a movement of the person according to the movement of the person.

9. The commodity marketing system as set forth in claim 1, wherein the synthesizing device has a function of synthesizing the image of the person taken by the imaging device with image information from the commodity database according to the movement of the person.

10. The commodity marketing system as set forth in claim 1, wherein the synthesizing device has a function of generating a synthesized image so as to be displayed three-dimensionally, and the display device has a function of displaying the image sent from the synthesizing device three-dimensionally.

11. The commodity marketing system as set forth in claim 1, wherein the commodity database has a function of storing and managing various data of commodities to be sold, and supplying image information that matches the person based on information from the customer database to the synthesizing device.

12. The commodity marketing system as set forth in claim 1, wherein the display device has a function of displaying an image of the person so that the person can see the image as his/her appearance that reflects in a mirror.

13. The commodity marketing system as set forth in claim 1, wherein the display device has a multiplicity of sets of pixels, each set of the pixels containing an element configured to emit light and an element configured to reflect light, and has a function of performing light emission and light reflection simultaneously.

14. The commodity marketing system as set forth in claim 1, wherein the input device is configured to input information by an operation to a button displayed on the display device.

15. The commodity marketing system as set forth in claim 1, wherein the input device is configured to input information when an operation of the person's operation is recognized as a predetermined operation by an image taken by the imaging device.

16. The commodity marketing system as set forth in claim 1, wherein the input device is configured to input information by voice of the person.

17. The commodity marketing system as set forth in claim 1, wherein the input device is configured to input information by a touch of the person to a main unit.

18. The commodity marketing system as set forth in claim 1, wherein the input device is configured to input information through the mobile terminal.

19. The commodity marketing system as set forth in claim 1, wherein the input device is configured to input information by holding the mobile terminal over a main unit.

20. The commodity marketing system as set forth in claim 4, wherein the delivery system has a function of delivering a commodity having a model number that fits the person among commodities purchased by customers who have been authenticated by the identification information of the mobile terminal based on information registered in the customer database.

21. (canceled)
